(19) United States
(12) Patent Application Publication
(10) Pub. No.: US 2012/0253899 A1
(43) Pub. Date: Oct. 4, 2012

(54) TABLE APPROACH FOR DETERMINING QUALITY SCORES

(75) Inventors: Tao Qin, Beijing (CN); Tie-Yan Liu, Beijing (CN); Wei Xie, Beijing (CN); Chi Gao, Beijing (CN); Zeyong Xu, Beijing (CN); Wei-Ying Ma, Beijing (CN)

(73) Assignee: Microsoft Corporation, Redmond, WA (US)

(21) Appl. No.: 13/078,329

(22) Filed: Apr. 1, 2011

(51) Int. Cl. G06Q 30/00

(52) U.S. Cl. 705/14.4

(57) ABSTRACT

Some implementations construct a quality score table based on historic data collected for a plurality of ad-keyword pairs. An ad-keyword pair may be selected for determining a quality score. One or more advertisement parameters may be determined for the selected ad-keyword pair. Based on the one or more advertisement parameters, the quality score for the selected ad-keyword pair may be determined from the quality score table. In some implementations, the quality score table is constructed by iteratively cutting a directed graph representing the advertisement parameters and the historic data. Further, in some implementations, the table may be smoothed using a smoothing operation.

### BACKGROUND

Advertising is typically the primary source of revenue for commercial search sites that provide search services to the public. When a user submits a search query to a commercial search site, an advertising service associated with the search site may decide whether to display one or more advertisements with the search results. Further, if advertisements are to be displayed, the advertising service also determines which ads to display from among available candidate ads, and how to rank or position the ads with the search results.

In some cases the ads are chosen based, at least in part, on an auction bidding process. In the auction bidding process, advertisers bid a certain amount to have their ads displayed with search results in response to queries containing one or more specified keywords. Thus, the amount of the bid may influence whether the ad is displayed and may also influence the rank or position of the ad. Additionally, various methods may be applied for charging the advertisers for the advertising service. For example, the advertisers may be charged based on the number of ad impressions displayed to users, may be charged when a user clicks on an ad displayed with the search results, and the like.

In such an advertising-based revenue model, it is desirable that the advertisements provide information that is useful to the user and relevant to the user's search query. For example, if the advertising service presents ads that a user finds useful, then the user will be more likely to click on the ads displayed, and also more likely to click on ads in the future. This can result in increased revenue for the advertising service, while also fulfilling the expectations of the advertisers. Accordingly, the advertising service may strive to ensure advertisement suitability by gauging the quality of advertisements submitted by advertisers.

To determine advertisement quality, a quality score may be used as a dynamic variable assigned to ads and keywords. The quality score may provide a measure as to how relevant a particular ad is to a particular keyword and/or to a user's search query. Thus, the quality score may influence whether an ad is displayed with search results, and the rank or position of the ad in the search results. Quality score may also be applied, at least in part, when determining the minimum value of bids accepted for particular keywords. For instance, the higher the quality score, the better the ad position and the lower the amount of the minimum accepted bid for a particular keyword. Consequently, being able to accurately estimate the quality score of an ad-keyword pair can provide benefits to the advertising service, the advertisers and the users of a search site.

### SUMMARY

This Summary is provided to introduce a selection of concepts in a simplified form that are further described below in the Detailed Description. This Summary is not intended to identify key or essential features of the claimed subject matter; nor is it to be used for determining or limiting the scope of the claimed subject matter.

Some implementations disclosed herein provide techniques for determining quality scores for advertisements and associated keywords. For example, some implementations herein provide a table-based approach for quality score estimation. In some implementations, training data is used to generate a table that can be used to determine quality scores. For example, a graph may be constructed based on the training data, and the graph may be cut into subgraphs to construct the table. Further, some implementations may employ a smoothing technique to smooth the table.

### BRIEF DESCRIPTION OF THE DRAWINGS

The detailed description is set forth with reference to the accompanying drawing figures. In the figures, the left-most digit(s) of a reference number identifies the figure in which the reference number first appears. The use of the same reference numbers in different figures indicates similar or identical items or features.

FIG. 1 illustrates an example framework for table-based quality score estimation according to some implementations.

FIG. 2 is a flow diagram of an example process for table-based quality score estimation according to some implementations.

FIG. 3 is an example of a search results page including advertisements ranked based, at least in part, on quality scores according to some implementations.

FIG. 4 illustrates an example structure of an advertiser ad group having advertisements and keywords according to some implementations.

FIG. 5 is a block diagram of an example system architecture for a search service including quality score estimation according to some implementations.

FIG. 6 is a block diagram illustrating a technique for constructing a table for quality score estimation according to some implementations.

FIG. 7 is an example table for quality score estimation according to some implementations.

FIG. 8 is a flow diagram of an example process for a table-based approach to quality score estimation according to some implementations.

FIG. 9 is a block diagram of an example computing device according to some implementations.

### DETAILED DESCRIPTION

### Determining Quality Scores

The technologies described herein generally relate to determining a quality score for an advertisement. For example, the quality score may be estimated for an advertisement or group of advertisements paired with a keyword (i.e., an ad-keyword pair) for use in an advertising service. Some implementations provide a lookup-type table approach for determining a quality score. A quality score table may be constructed using, as training data, historic data recorded for a plurality of ad-keyword pairs. For example, a directed graph may be constructed based on the training data. Next, a graph division or cutting technique may be applied to the graph to generate the quality score table. Further, in some implementations, the quality score table may be smoothed, such as by using a greedy smoothing technique, to achieve a monotonic increasing property. The smoothing can help limit the effects of any noisy training data and ensure that the results obtained during use of the quality score table remain consistent with the basic underlying assumptions and expectations.

As used herein the term “ad-keyword pair” may refer to a single advertisement or may refer to a group of advertisements (i.e., an ad group) that is paired with a bid keyword. For example, an ad group may include a one or more ads and one or more keywords that the advertiser would like the ads displayed in association with. Thus, depending on a desired implementation, quality scores may be determined for individual ads, for ad groups, or for both.

According to some implementations, for a particular ad-keyword pair, three advertisement parameters may be determined, notated herein as a triple (x, y, z). The ad parameter x may represent the relevance between the keyword and the ad group. For example, an ad typically includes one or two lines of text (referred to as “ad copy”), which along with a hyperlink to a landing page, are typically presented to a user with the search results. Accordingly, relevant ad copy should contain the bid keyword to be relevant. It is also desirable for the ad copy to include good grammatical structure, dynamic text, unique selling points, be focused toward an identified potential customer, and motivate the user to click on the ad. The ad parameter y may represent the relevance between the keyword and the landing page of the ad group. For example, landing page relevance may refer to the relevance of a webpage that a user is directed to when the user clicks on an ad (e.g., clicks on the hyperlink displayed with the ad copy). The landing page should be directly related to the ad and the bid keyword and/or the keywords contained in user's search query. The ad parameter z may represent the quality of the landing page. Landing page quality refers to the quality of the webpage that the user is directed to when the user clicks on an ad. For example, the landing page should adhere to certain editorial guidelines, be well organized, and make it easy for the user to purchase a product, sign up for a service, create an account, or the like. Further, the landing page should not contain a large amount of unrelated advertising, not contain misleading offers, spyware, or have functionality problems.

Various algorithms may be executed for determining the ad parameters (x, y, z) according to the considerations set forth above. In some implementations, the three ad parameters (x, y, z) may be quantified as integers, ranging from 1 to 10 so that there are ten possible values for each parameter, with 1 representing a low relevance or quality, and 10 representing a high relevance or quality. Implementations herein determine the quality score based on the given triple (x, y, z). According to some implementations, the quality score may be an integer, and may also range from 1 to 10. However, quality scores 9 and 10 are typically reserved, so the actual quality score may range in value from 1 to 8. Accordingly, given the three parameters (x, y, z) determined for a particular ad-keyword pair, implementations herein may use a quality score table to determine a quality score having a value between 1 and 8 to represent the particular ad keyword pair.

In some implementations, underlying quality score estimation represented by the quality score table is based on a rank correlation between the quality score and a ground truth. For example, the ground truth could be some historic performance indicator (PI) or other historic data that has been recorded for a plurality of ad-keyword pairs that have been in use in the ad service. Suitable historic PIs may include number of impressions, number of clicks, click through rate, or the like. The number of impressions is the number of times that an ad is displayed to users, such as in a search results pages. The number of clicks is the number of times that users click on the displayed ad. The measured click-through rate is the number of times the ad is actually clicked on in comparison with the number of impressions of the ad that have been presented. Further, each keyword is typically associated with plurality of ads or ad groups of a plurality of advertisers. These ad groups associated with the same keyword can be ranked according to the quality scores, and can also be ranked according to the ground truth.

Because the relationship between the quality score and the three ad parameters (x, y, z) can be complicated, a simple linear combination of the three ad parameters may typically be inadequate for consistently determining an accurate quality score. Accordingly, rather than utilizing a linear combination approach, such as an explicit function to map the triple (x, y, z) to a quality score, implementations herein construct a quality score table for mapping an ad-keyword pair to a quality score. For example, given the triple (x, y, z), implementations herein are able to determine a subgraph location for the ad-keyword pair and thereby, based on the identified subgraph, determine a quality score from the quality score table.

Some implementations herein may employ several steps to construct the quality score table. In a first step, a directed graph may be constructed based on the historic performance training data. Next, a quality score table is generated using an iterative graph cutting technique to generate a plurality of subgraphs. Each subgraph may correspond to different quality score value. Additionally, a smoothing operation may be used in some implementations to improve the consistency of the results achieved during application of the quality score table. Further, the table construction process herein utilizes a machine-learning-based approach. For example, the first two steps employ training data such as historical auction performance data and results. As mentioned above, the training data may include the historic logs of at least one performance indicator as training data, which may have been collected over a period of time, such as an immediately preceding week.

Following construction of the quality score table, the quality score table may be used to determine quality scores for any existing ad-keyword pairs for which the ad parameters (x, y, z) can be determined. Further, because the training data may change on a regular basis, the quality score table may be updated regularly and thereby the quality scores for current ad-keyword pairs may be dynamically and automatically updated on a regular basis without human involvement. Accordingly, the quality score table herein enables the quality scores to remain current and accurate over time as the ad service and/or an associated search service evolves.

In some implementations, the quality scores determined for a plurality of ad-keyword pairs may be used by the advertising service when determining when and where to use ads, how to rank ads, and the like. Additionally, the quality scores may be applied when determining an amount of a minimum acceptable bid for an ad-keyword pair of an advertiser. Furthermore, the advertising service may provide the quality score for a particular ad-keyword pair as feedback to the advertiser to enable the advertiser to improve the ad, and thereby improve the ad ranking and placement. By improving the quality scores of their ads, advertisers may improve the rankings and effectiveness of their ads, since users are more likely to click on ads of higher quality. Further, because payment by the advertisers to the advertising service may be based, at least in part, on whether users actually click on the ads, having ads of higher quality can also increase the revenue of the advertising service.

### Example Framework

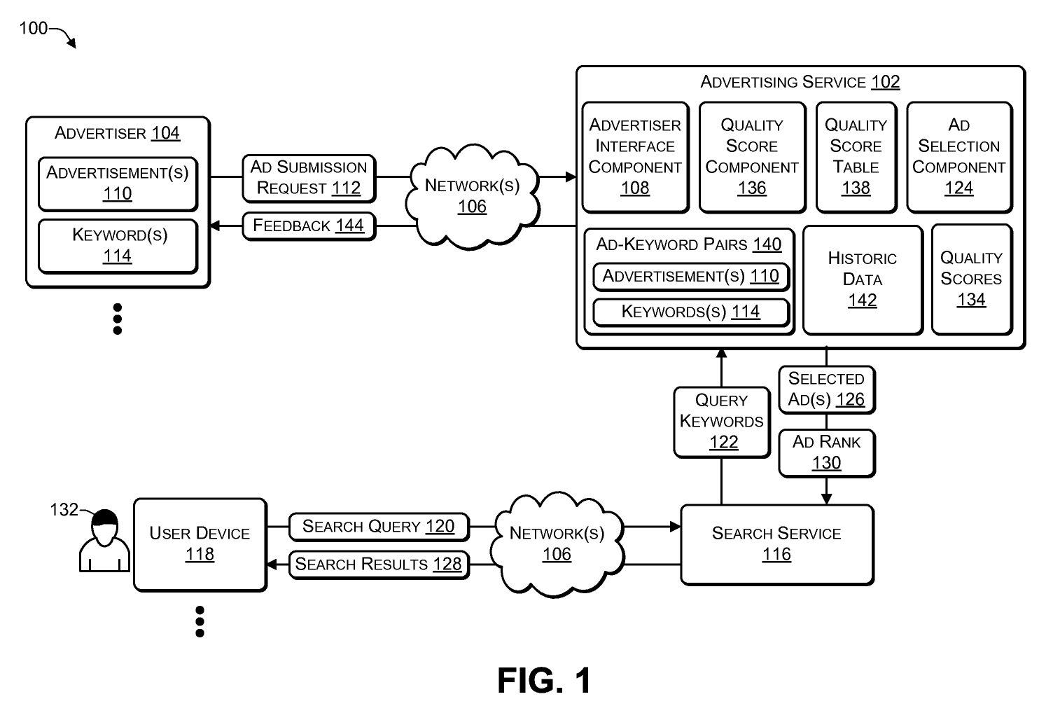

FIG. 1 illustrates an example framework 100 for quality score estimation of advertisements according to some implementations. In the illustrated example, an advertising service 102 is in communication with one or more advertisers 104 through one or more network(s) 106. Network(s) 106 may include the Internet, a local area network (LAN), a wide area network (WAN), a wireless network, or other suitable communication network, or a combination of networks, enabling communication between advertising service 102 and advertiser 104. Thus, advertisers 104 may conduct business with and manage their advertisements with advertising service 102 through network(s) 106 or through other suitable communication functionalities.

Advertising service 102 may include an advertiser interface component 108 that enables advertiser 104 to access and utilize advertising service 102. Advertiser interface component 108 may provide a series of webpages, or the like, that present a graphic user interface to advertiser 104 to enable advertiser 104 to submit one or more advertisements 110 to advertising service 102. For example, advertiser 104 may submit an advertisement 110 in an ad submission request 112 transmitted to advertising service 102 over network(s) 106. In some implementations, advertiser 104 may use the advertiser interface component 108 to create the advertisement 110, while in other implementations, the advertiser 104 may create the advertisement 110 independently and submit the advertisement 110 to the advertiser interface component 108 with the ad submission request 112.

The ad submission request 112 may further identify one or more keywords 114 that the advertiser 104 would like the advertisement 110 to be displayed in connection with. Additionally, in implementations in which the advertising service 102 uses an auction-type revenue model, the ad submission request 112 may also include a bid amount that the advertiser 104 is willing to pay the advertising service 102 for displaying the advertisement 110 in connection with the keyword 114. For example, the advertiser may pay an amount for each impression of the ad presented to a user (pay-per-impression), may pay for each click on the ad by a user (pay-per-click), or combinations thereof. Other payment models may also be used, such as pay-per-sale, pay-per-page-visit, pay-per-lead (e.g., filling out a form at the advertiser's website), or the like.

In the example illustrated, advertising service 102 may be associated with a search service 116. However, other implementations of advertising service 102 contemplated herein are not limited to use with a search service. One or more user devices 118 may be in communication with search service 116 through network(s) 106, which may include the same network type as that used for communication between advertiser 104 and advertising service 102, or a different network type. For example, the user device 118 may submit a search query 120 to search service 116 over network(s) 106. When the search service 116 receives the search query 120, the search service 116 may provide one or more query keywords 122 from the search query 120 to the advertising service 102. In response, an ad selection component 124 of the advertising service 102 may identify one or more selected ads 126 to be displayed with search results 128 that will be provided in response to the search query 120. The advertising service 102 may also include position or ranking information as ad rank 130 when there are multiple selected ads 126. The search service 116 may then assemble the search results 128 with the selected ads 126, such as in the form of a webpage, to provide search results 128 to the user device 118. The search results 128 may include the one or more selected ads 126 placed in the search results 128 in accordance with the ad rank 130 provided by the advertising service 102.

The user device 118 receives and displays the search results 128 to a user 132. In the case of a pay-per-impression agreement between the advertiser and the advertising service 102, the impression of a selected ad 126 to the user 132 can be recorded and the advertiser 104 charged accordingly. Further, the user 132 may choose whether or not to click on or otherwise select one of the selected ads 126 included in the search results 128. If the user 132 does click on a selected ad 126, this action can be detected by the search service 116. In the case of a pay-per-click agreement between the advertiser 104 and the advertising service 102, the click event can be recorded and the advertiser 104 charged accordingly.

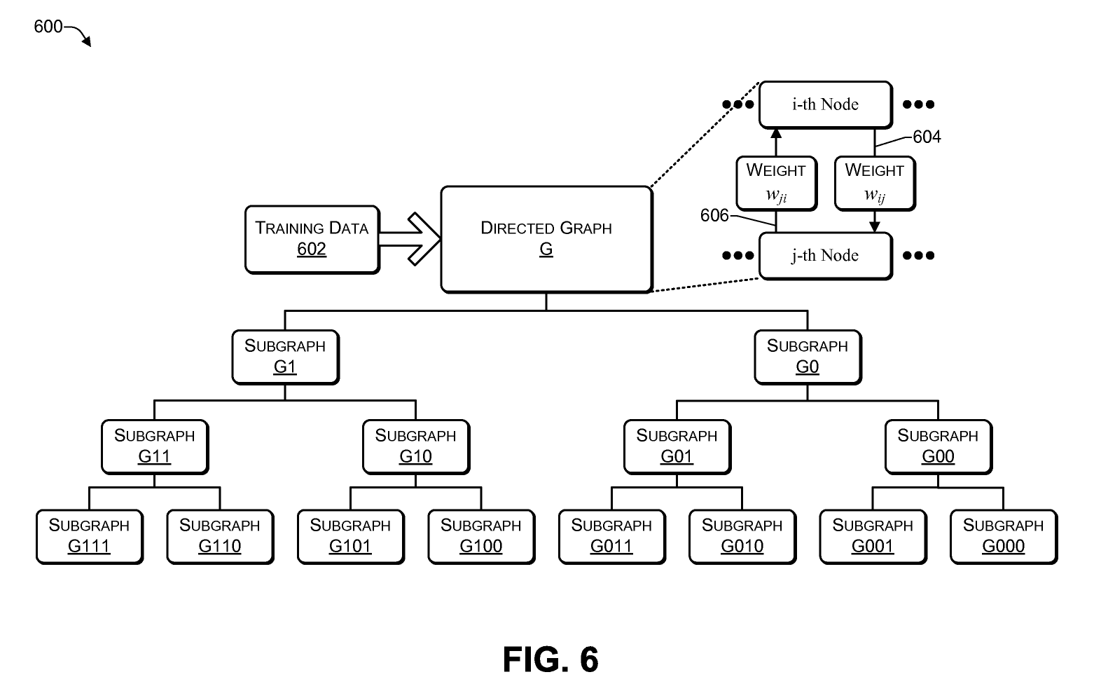

When determining whether any ads 110 should be selected as selected ads 126, which ads 110 to select, and the ad rank 130 identifying a ranking or position of the selected ads 126, ad selection component 124 may employ quality scores 134, as determined by a quality score component 136. The quality score component 136 may be configured to determine quality scores 134 using a quality score table 138 for each advertisement-keyword pair 140. The quality score component 136 may construct the table during a table construction stage. The quality score component 136 may then subsequently use the quality score table 138 to determine quality scores 134 for the ad-keyword pairs 140. As mentioned above, in some implementations, the quality score component 136 may construct the quality score table 138 using historic data 142 collected over a period of time for a plurality of ad-keyword pairs 140. For example, historic data 142 may include historic performance data for the plurality of ad-keyword pairs and a plurality of corresponding advertisement parameters (x, y, z) for the plurality of ad-keyword pairs. Additional details of constructing and using the quality score table 138 are discussed below with reference to FIGS. 6-8.

As mentioned above, the quality score component 136 may periodically recalculate or reconstruct the quality score table 138 based on the latest available set of training data, and may then recalculate the quality scores 134 for the add-keyword pairs 140. Since the advertising service 102 is a dynamic system and because the quality score component 136 herein adopts a machine-learning approach to constructing the quality score table 138, the quality score component 136 is able to dynamically change and update the quality score table 138 as the advertising service 102 (and the search service 116) evolve. Accordingly, the quality scores 134 can be kept current and accurate through the periodic updating of the quality score table 138 and the quality scores 134. Additionally, in some implementations, advertising service 102 may provide feedback 144 to an advertiser 104 regarding the quality scores 134 determined for the advertiser's advertisements 110. For example, when the quality score 134 for an ad-keyword pair 140 has been determined by the quality score component 136, the advertising service 102 may provide the estimated quality score 134 to the advertiser 104 to enable the advertiser to attempt to improve the quality score 134.

### Example Process

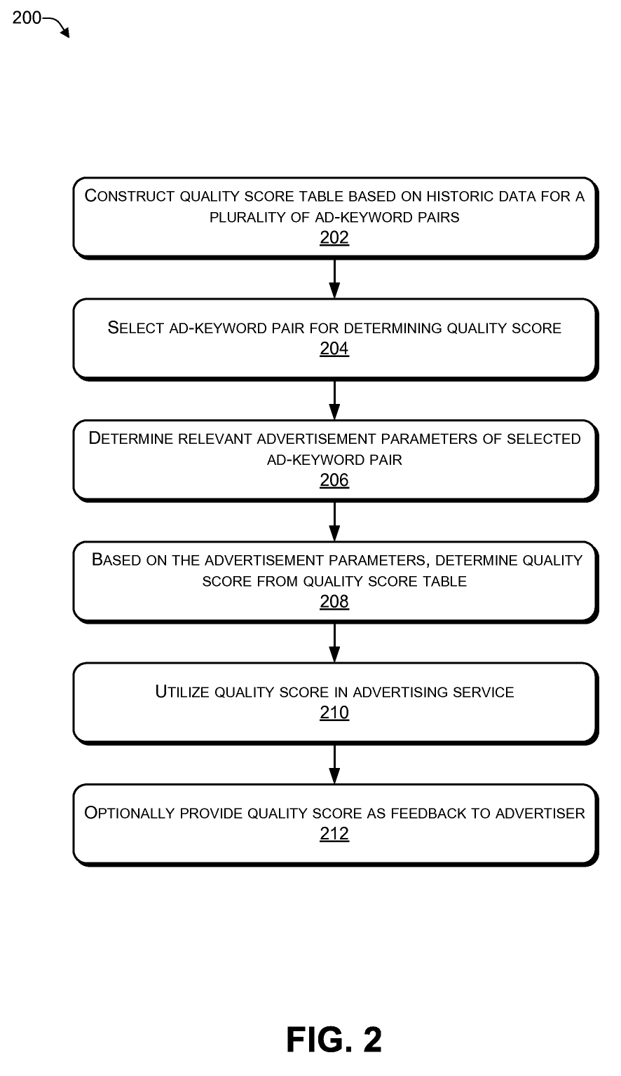

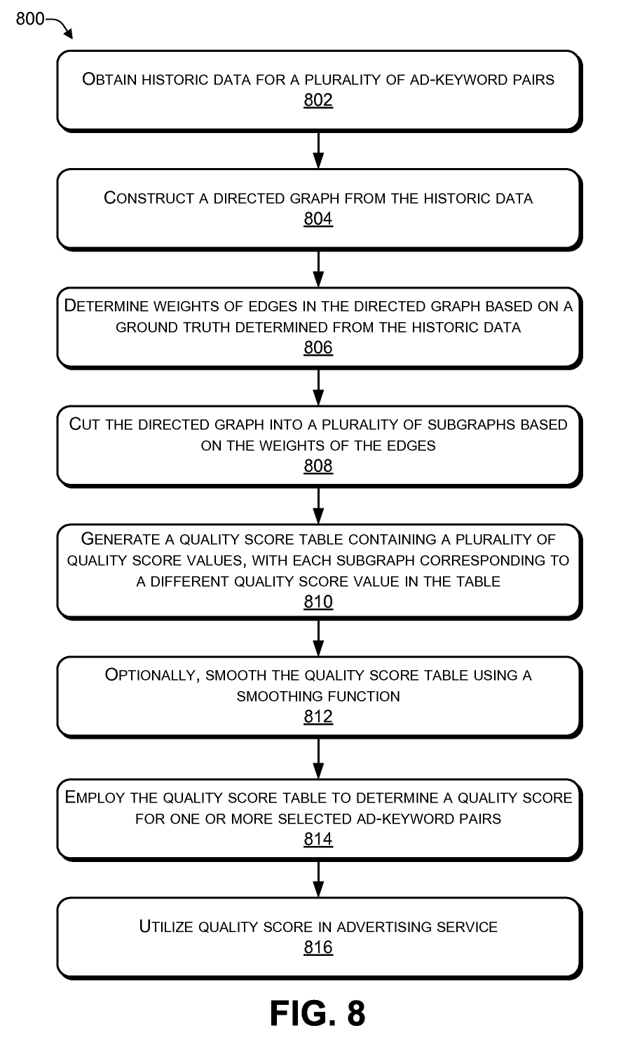

FIG. 2 is a flow diagram of an example process 200 for quality score estimation according to some implementations herein. In the flow diagram of FIG. 2, as well as in the flow diagram of FIG. 8, each block represents one or more operations that can be implemented in hardware, software, or a combination thereof. In the context of software, the blocks represent computer-executable instructions that, when executed by one or more processors, cause the processors to perform the recited operations. Generally, computer-executable instructions include modules, programs, objects, components, data structures, and the like that perform particular functions or implement particular abstract data types. The order in which the blocks are described is not intended to be construed as a limitation, and any number of the described operations can be combined in any order and/or in parallel to implement the process. For discussion purposes, the process 200 is described with reference to the framework 100 of FIG. 1, although other frameworks, architectures, systems and environments may implement this process.

At block 202, the quality score component 136 constructs a quality score table based on historic data for a plurality of ad-keyword pairs provided in a set of training data. For example, the historic data may include historic performance data for the plurality of ad-keyword pairs and a plurality of corresponding advertisement parameters (x, y, z) for the plurality of ad-keyword pairs. As described in detail below, the quality score component 136 may construct a preference graph from the training data and may cut the graph iteratively into a plurality of subgraphs, with each subgraph corresponding to different quality score value in the quality score table.

At block 204, the quality score component 136 selects an ad-keyword pair for determining a quality score. For example, the ad-keyword pair may have been in use by the advertising service for a period of time sufficient to establish historic data 142, such as one or more performance indicators, e.g., click through rate, number of clicks, number of impressions, and the like.

At block 206, the quality score component 136 determines the relevant ad parameters (x, y, z) of the selected ad-keyword pair. For example, the quality score component may use one or more algorithms to determine and assign values between 1 and 10 for each of the ad parameters (x, y, z). As mentioned above, the ad parameter x may represent the relevance between the keyword and the ad or ad group. For example, relevant ad copy should contain the bid keyword at least once to be relevant. It is also desirable for the ad copy to include good grammatical structure, dynamic text, unique selling points, be focused toward an identified potential customer, and motivate the user to click on the ad. The ad parameter y may represent the relevance between the keyword and the landing page of the ad or ad group. For example, the landing page should be directly related to the ad and the bid keyword. The ad parameter z may represent the quality of the landing page. For example, the landing page should adhere to certain editorial guidelines, be well organized, and should make it easy for the user to purchase a product, sign up for a service, create an account, or the like. Further, the landing page should not contain a large amount of unrelated advertising, should not contain misleading offers, spyware, or have functionality problems.

At block 208, based on the ad parameters (x, y, z) for the selected ad-keyword pair, the quality score component 136 determines the quality score from the quality score table. For example, the quality score component determines which subgraph of the plurality of subgraphs the selected ad-keyword pair belongs in, and from there is able to determine the quality score from the quality score table.

At block 210, the advertising service 102 utilizes the quality score in the advertisement service. For example, the ad service may apply the quality score during selection of advertisements, such as for use by a search service when providing search results in response to a search query. Additionally, the ad service may apply the quality score when determining minimum acceptable bids for the ad, the ad group or the advertiser.

At block 212, optionally, the advertising service 102 may provide the quality score for the ad-keyword pair to the advertiser 104 as feedback.

Example Search Results Page with Ads Ranked by Quality Score

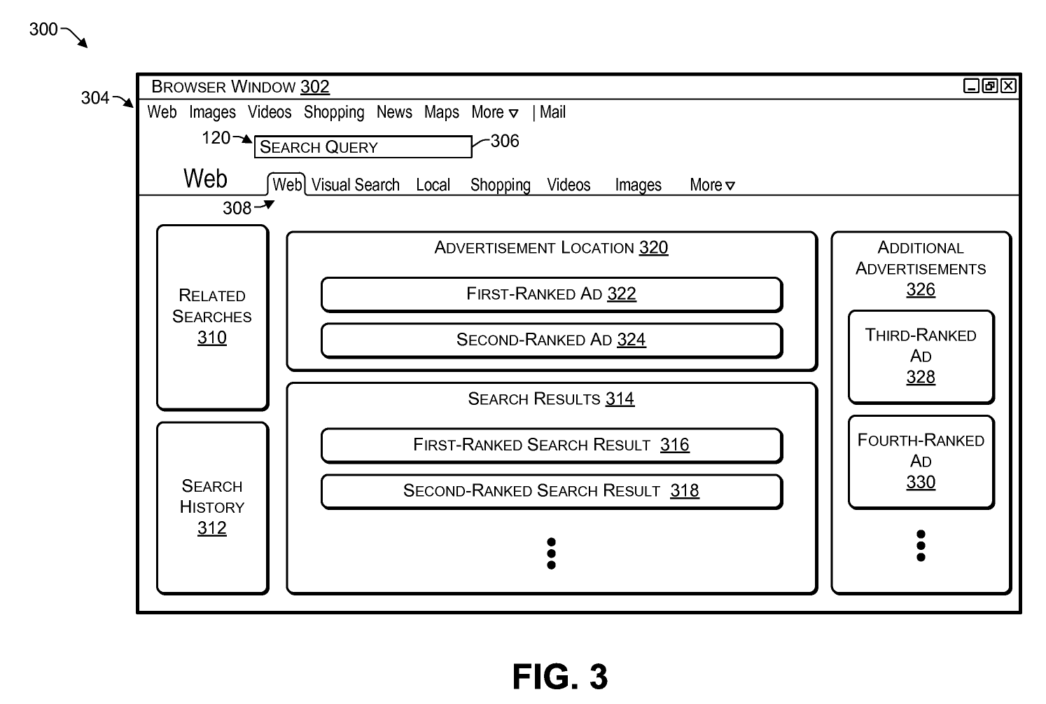

FIG. 3 illustrates an example search results page 300 that the user 132 may receive from search service 116 as search results 128 in response to the search query 120 according to some implementations herein. For example, as mentioned above, when the user 132 issues the search query 120 to the search service 116, the ad selection component 124 decides whether to display some ads 110, which ads 110 to display, and how to rank the ads 110 when more than one ad 110 is selected to be displayed. One or more selected ads 126 may be included in the search results 128, positioned according the ad rank 130 determined by ad selection component 124.

In the illustrated example, search results page 300 may be displayed in a browser window 302, and may include a search menu 304 for selecting a resource to be searched, such as the “Web,” “images,” “videos,” “shopping,” “news,” “maps,” or “more,” along with an option to access email. Search results page 300 may further include a query entry window 306 for receiving the search query 120, and a results source menu 308 indicating a source of the results, e.g., the “Web,” “visual search,” “local,” “shopping,” “videos,” “images,” and “more.” Search results page 300 may further include a listing of related searches 310 and/or a search history 312. The search results page 300 may further include a presentation of search results 314 determined by the search service 116 to be relevant to the search query 120, such as a first-ranked search result 316, a second-ranked search result 318, and so forth.

According to some implementations herein, the search results page 300 may include one or more advertisements positioned or ranked based, at least in part, on a quality score 134 determined by the quality score component 136. In the illustrated example, an advertisement location 320 may immediately precede the search results 314, and may include one or more advertisements, such as a first-ranked ad 322 and a second-ranked ad 324. A location for additional advertisements 324 may be positioned to one side of search results 314, and may include a third-ranked ad 328, a fourth-ranked ad 330, and so forth. According to one possible method for determining ad rank 130, the ad rank 130 may be equal to the bid amount multiplied by the quality score. Thus as an example, when ad rank 130 is determined according to this method, if the bid amount for ads 322, 324, 328 and 330 was the same amount, then the rank of ads 322, 324, 328 and 330 would correspond to the quality score 134 for each ad. Thus, in this example, first-ranked ad 322 may have a higher quality score 134 than second-ranked ad 324, second-ranked ad 324 may have a higher quality score 134 than third-ranked ad 328, and so on.

When the user 132 clicks on one of the ads 322, 324, 328 or 330, the user's browser window 302 may be redirected to a landing page (not shown in FIG. 3) associated with the clicked-on ad. For example, the landing page may be a webpage that contains more information about the advertised product or service, provides an opportunity to purchase or sign up for the advertised product or service, and the like). Also, in some revenue models, the advertiser 104 who owns the clicked-on ad may be charged for the click on the ad or other actions made by the user 132 at the landing page. Further, while FIG. 3 illustrates one example configuration for a search results page, numerous other configurations and arrangements are possible, and implementations herein are not limited to any particular configuration.

### Example Advertisement Organization

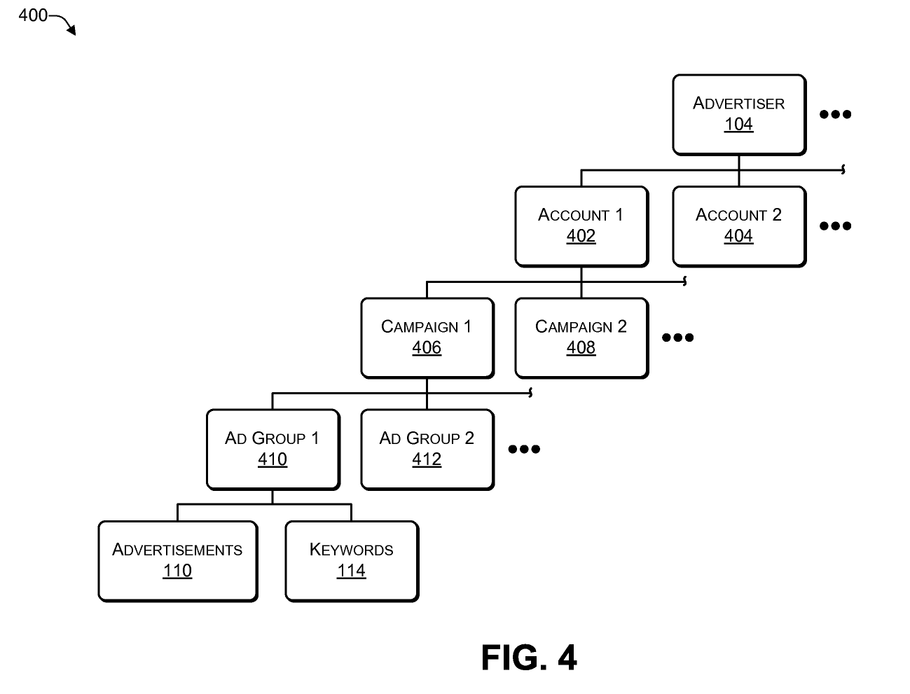

FIG. 4 illustrates an example structure 400 of how advertisements might be organized by an advertiser 104 for use with an advertising service, such as advertising service 102, according to some implementations herein. Advertiser 104 may have one or more accounts with ad service 102, such as account one 402, account two 404, and so forth. Each account may include one or more campaigns, such as campaign one 406, campaign two 408, and so on. For example, each campaign might relate to a cdifferent product or service of the advertiser 104. Each campaign may include one or more ad groups, such as ad group one 410, ad group two 412, etc. The advertisements 110 and keywords 114 may thus be organized into a particular ad group, such as ad group one 410 in the illustrated example. In each ad group 410, 412 there may be one or more ads 110 and one or more keywords 114. For example advertiser 104 may desire to associate each ad 110 with a number of different keywords 114 related to the product or service being advertised. Further, different ad copy may be used for different keywords in an ad group 410, 412 so that the ads 110 appear relevant to particular keywords 114 corresponding to query keywords 122 submitted in user search requests, and are thus more likely to be clicked on by a user. A quality score 134 may be determined for each ad-keyword pair in an ad group. The quality score 134 may then be used in any of several different ways, such as influencing the actual cost-per-click (CPC) for keywords (i.e., the minimum acceptable bid). The quality score 134 may also be used for determining whether an ad bid on a keyword is eligible to enter an ad auction. The quality score 134 may also be used when determining the rank or position in which an ad will be ranked in search results. In general, ads having a higher quality score 134, incur a lower cost and achieve a better ad rank

### Example System Architecture

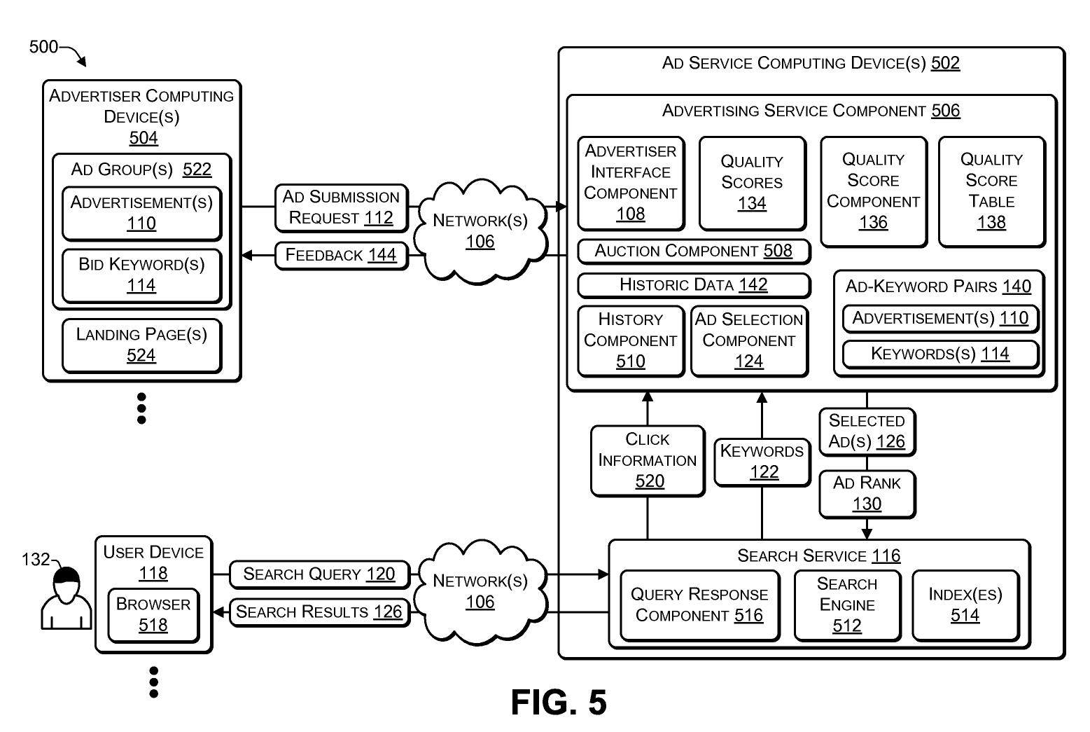

FIG. 5 is a block diagram of an example system architecture 500 for providing an advertising service including quality score determination according to some implementations herein. The system architecture 500 may incorporate, at least in part, the framework 100 of FIG. 1. In the illustrated system architecture 500, one or more ad service computing devices 502 are in communication with one or more advertiser computing devices 504 through network(s) 106. Advertising computing device 502 includes an advertising service component 506 that may include advertiser interface component 108, ad selection component 124, quality scores 134, quality score component 136, quality score table 138, ad-keyword pairs 140, and historic data 142. As described above, quality score component 136 may determine quality scores 134 for ad-keyword pairs 140 by constructing and using quality score table 138, as discussed additionally below with reference to FIGS. 6-8.

Advertising service component 506 may further include an auction component 508 and a history component 510. Auction component 508 may manage the auction portion of the advertising service. For example, the auction component may set minimum bids for particular ad-keyword pairs 140, may receive and manage the bids from advertisers, perform billing functions, and the like. History component 510 may maintain a history of historic data 142 for each ad keyword pair 140. For example, history component 510 may track the click-through rate, the number of impressions, the number of clicks, and other aspects and actions recorded with respect to each ad-keyword pair 140. The history component 510 may provide the historic data 142 for each ad-keyword pair 140 to quality score component 136 for use in generating quality score table 138 and determining quality scores 134. The history component 510 may also provide history information to auction component 508 for billing purposes, minimum bid determination, and the like.

Search service 116 may run on the same computing device(s) 502 as advertising service component 506, or on separate computing devices dedicated to the search service 116. Search service 116 may include a search engine 512, one or more search indexes 514 and a query response component 516. When the search query 120 is received by the search service 116, query response component 516 provides query keywords 122 from the search query 120 to the ad selection component 124 and receives back the selected ads 126 and the corresponding ad rank 130. Query response component 516 may then assemble the search results 128 in a search results page as described above with reference to FIG. 3, including the selected ads 126 assembled according to the ad rank 130. A browser 518 at user device 118 may display the search results 128 to the user 132. Furthermore, the query response component 516 may track whether the user 132 clicks on any of the ads in the search results 128, and may provide click information 520 to the history component 510 to enable the history component 510 to keep a record of clicks or other user actions taken for each ad-keyword pair 140.

Advertiser computing device 504 may include one or more ad groups 522, as described above with reference to FIG. 4, each of which may include one or more advertisements 110 and one or more keywords 114. Advertiser computing device 504 may further include one or more landing pages 524. For example, in some implementations, the landing pages 524 may be maintained in a website hosted on advertiser computing devices 504. However, in other implementations, landing pages 524 may be maintained in one or more websites hosted on other web hosting computing devices (not shown) on behalf of advertisers 104. Furthermore, while FIG. 5 illustrates one possible suitable system architecture 500 according to some implementations, numerous variations will be apparent to those of skill in the art in view of the disclosure herein.

### Example Quality Score Table Construction

FIG. 6 is a block diagram illustrating an example 600 of building and cutting a directed graph G during generation of the quality score table 138 according to some implementations herein. For example, one or more quality score tables 138 may be generated by the quality score component 136 described above with reference to FIGS. 1 and 5. As mentioned above, the quality score table-based approach herein is unlike a linear approach in that an explicit linear function is not used to map the triple (x, y, z) to a quality score. Instead, implementations herein construct a lookup-type table that can be used for determining quality scores 134. For example, based on a determined triple (x, y, z) for an ad-keyword pair, the quality score component 136 can use the quality score table 138 to look up a quality score 134.

The table construction technique herein utilizes a machine-learning-based approach. For example, the table construction may employ training data 602, such as logs of historical auction data and click results. The training data 602 may include one or more performance-based metrics or indicators from the historic data 142 as training data. The performance indicator may be used as a ground truth when constructing the graph G. The training data 602 may have been collected over a period of time, such as an immediately preceding week, or other period of time. Thus, suppose that there are K keywords that participated in ad auctions in the past week, and each keyword is associated with nᵢ ads or ad groups. Then, (xⱼⁱ, yⱼⁱ, zⱼⁱ) may be used to indicate the ad parameters of the pair of i-th keyword and its j-th ad group, and gⱼⁱ may be used to indicate the ground truth of this pair. As mentioned above, the ground of truth may be based on historical performance of the ad-keyword pair, such as click through rate, number of clicks, number of impressions, or the like, recorded over the time period, such as during the past week.

As mentioned above, the three ad parameters (x, y, z) are based on ad-keyword features. For example, x can be a keyword-ad copy relevance score, y can be a keyword-landing page relevance score, and z can be a landing page quality score, each of which may be determined based on various features and considerations, as discussed above. Suitable algorithms for determining the three ad parameters (x, y, z) are well established by advertising services and thus are not further described herein. According to some implementations herein, the three ad parameters (x, y, z) may all be assigned integer values ranging between 1 and 10. Therefore, the three ad parameters (x, y, z) are each located in the group [1,10], and thus, there are at most 1000 different triples of (x, y, z). The 1000 different triples of (x, y, z) may be assigned to an index based on the following:

I(x,y,z)=100x+10y+z−111 EQ (1)

Accordingly the index of the triples may start at 0 and end at 999. Next, some implementations herein may construct the directed graph G having 1000 nodes (0-999). Thus, in the directed graph G, node i represents the triple (x, y, z) which has index i: I(x, y, z)=i. Furthermore, in the directed graph G, a weight W_{i,j} of an edge 604 from the i-th node to the j-th node indicates how many times the i-th triple wins over the j-th triple according to the ground truth for the corresponding ad-keyword pairs. Similarly, a weight w_{j,i} of an edge 606 from the j-th node to the i-th node indicates how many times the j-th triple wins over the i-th triple according to the ground truth for the corresponding ad-keyword pairs. The weights of the edges may be initialized as follows:

w_{i,j}=0,∀0≦i,j≦999

Next, to apply the weights to the edges of the directed graph G, the quality score component 136 may traverse the training data 602 and determine weights of each of the edges in the graph. For example, if the i-th node represents the triple (xᵢ, yᵢ, zᵢ) and the j-th node represents the triple (xⱼ, yⱼ, zⱼ), and if click-through rate is used as the ground truth, then, during traversal of the training data, each time an ad-keyword pair corresponding to the triple (xᵢ, yᵢ, zᵢ) has a higher click-through rate than an ad-keyword pair corresponding to the triple (xⱼ, yⱼ, zⱼ), then a point may be added to the weight w_{i,j} of the edge 604. On the other hand, if the ad-keyword pair corresponding to the triple (xⱼ, yⱼ, zⱼ) has the higher click-through rate, then a point may be added to the weight w_{j,i} of edge 606. Further, while click-through rate is used as an example of the ground truth in this example, other suitable performance indicators may alternatively be used as the ground truth. The following pseudocode sets forth example instructions that the quality score component 136 may execute to perform this operation.

```
For each keyword in the training data
{
    For any two ads or ad groups (with signals (x₁,y₁,z₁) and
    (x₂,y₂,z₂), and with ground truth g₁ and g₂ associated with the
    keyword
    {
        If g₁ > g₂,W_{I(x}_{₁}_{,y}_{₁}_{,z}_{₁}_{),I(x}_{₂}_{,y}_{₂}_{,z}_{₂}₎ + +;
        If g₁ < g₂ , W_{I(x}_{₂}_{,y}_{₂}_{,z}_{₂}_{),I(x}_{₁}_{,y}_{₁}_{,z}_{₁}₎ + +;
    }
}
```

Following determining the weights of the edges of the directed graph G, as described above, the quality score component 136 may generate a quality score table 138 using an iterative graph cutting operation, as illustrated in FIG. 6. In this operation, the quality score component 136 may divide or cut the directed graph G into 8 partitions or subgraphs corresponding to quality score values 1-8 (keeping in mind that quality score values 9 and 10 are typically reserved). Accordingly, to iteratively cut the graph G, in some implementations, the quality score component 136 may cut the directed graph G into two subgraphs, G0 and G1. During the cutting, for each node i in the graph G, the quality score component 136 can count the in-degree and out-degree of the node i as follows:

$$IN ( i ) = {\sum }_{j ∈ G} {w}_{j , i}$$

$$OUT ( i ) = {\sum }_{j ∈ G} {w}_{i , j}$$

In which jεG indicates that node j is in the graph. For each node i in the graph, if

IN(i)<OUT(i)

then that node will be will be put into the sub graph G1, else that node will be put into the sub graph G0. In this way, the graph is divided into two subgraphs G0 and G1. Next, using the same technique, the quality score component 136 can further cut the subgraph G1 into two sub graphs G11 and G10, and cut the subgraph G0 into two sub graphs G01 and G00. Finally, the quality score component 136 may similarly cut the four subgraphs G00, G01, G10 and G11 to generate eight subgraphs G000, G001, G010, G011, G100, G101, G110 and G111.

### Example Quality Score Table

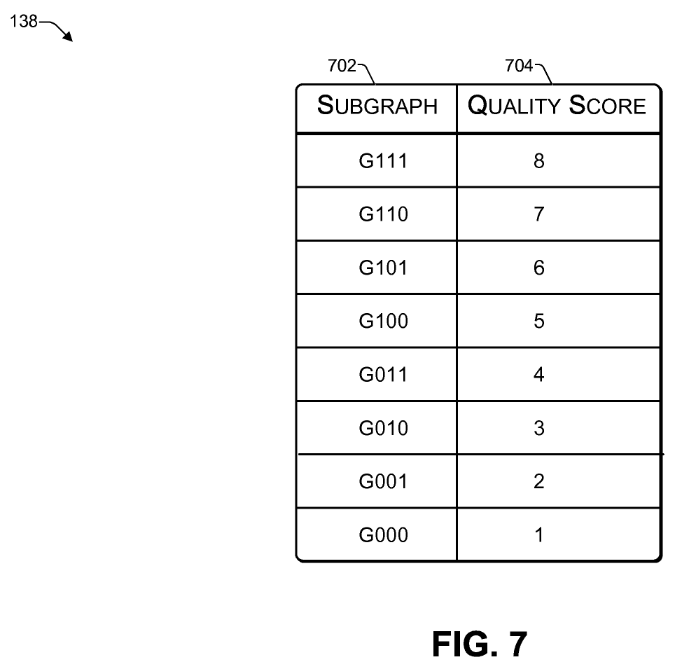

FIG. 7 illustrates an example configuration of a quality score table 138 that may be generated based on the eight subgraphs G000, G001, G010, G011, G100, G101, G110 and G111 according to some implementations herein. The example quality score table 138 includes a listing 702 of subgraphs G000, G001, G010, G011, G100, G101, G110 and G111, and corresponding quality scores 704 having quality score values 1-8. Thus, under this model for generating a quality score table 138, the nodes/triples in a same final sub graph G000, G001, G010, G011, G100, G101, G110 or G111 share a same quality score value.

When using the quality score table to determine a quality score for a selected ad-keyword pair 140, the quality score component 136 determines the ad parameter triple (x, y, z) for the selected ad-keyword pair 140 and then determines in which subgraph G000, G001, G010, G011, G100, G101, G110 or G111 the triple (x, y, z) is located. For example, suppose that a selected ad-keyword pair 140 has an ad parameter x with a value of 8 representing the relevance between the keyword and the ad group, an ad parameter y with a value of 6 representing the relevance between the keyword and the landing page of the ad group, and an ad parameter z having a value of 9 representing the quality of the landing page. Thus, the parameter triple for the ad-keyword pair in this example is (8, 6, 9). Further, suppose that the quality score component 136 determines that this triple (8, 6, 9) is located in the subgraph G110. Accordingly, based on the quality score table 138, the quality score for the selected ad-keyword pair would be 7. Further, it should be noted that while implementations herein assign quality scores having values between 1 and 8 to ad-keyword pairs, in other implementations, the different values or ranges of values may be used for quality scores. For example, the directed graph G may be divided into any number of subgraphs, each of which may represent a different quality score value. Further, the ad parameters (x, y, z) may also be assigned different values or ranges of values, and thus directed graphs G of different sizes and number of nodes may be generated. Additionally, rather than merely relying on the three ad parameters (x, y, z), in some implementations, other ad parameters may be included or may replace the three ad parameters (x, y, z). Numerous other variations will be apparent to those of skill in the art in view of the disclosure herein.

### Example of Smoothing the Quality Score Table

The quality score table 138 constructed as described above may be used to determine quality scores 134. However, the quality score table 138 may benefit from smoothing to bolster consistency and to decrease any impact of noisy (irregular) training data. Accordingly, it may be desirable for the quality score table 138 to be smoothed so as to ensure a monotonic increasing property, i.e., to ensure that larger ad parameters (x, y, z) will generally lead to a larger quality score, such as:

x₁≧x₂,y₁≧y₂,z₁≧z₂=>QS(xᵢ,yᵢ,zᵢ)≧QS(x₂,y₂,z₂).

However, the raw quality score table 138 as constructed above may not always demonstrate this property in some cases. Accordingly, to ensure monotonicity, the quality score table 138 may be smoothed using a smoothing operation. While various smoothing algorithms may be implemented, an example of a suitable smoothing operation may be a greedy smoothing algorithm. In some implementations, instructions for performing the smoothing operation may be executed based on the following pseudocode. In some implementations, this algorithm is applied on the raw quality score table 138. That is, the algorithm may take in the raw quality score table as input, and output a smoothed quality score table.

```
n=10
for x=1:n
      for y=1:n
            for z=1:n
                  QS(x, y, z) = min QS(x:n, y:n, z:n);
            end
      end
end
```

Accordingly, in view of the foregoing, it may be seen that implementations herein provide for a machine-learning-based approach to determining quality scores for ad-keyword pairs. A quality score table can be constructed and updated automatically as the training data is updated. Since the training data is simply the historical data already gathered in an advertising service, the training data may be easily obtained from an actual ad platform and can reflect actual market dynamics. Furthermore, the quality score table according to implementations herein is able to capture more complex relationships between quality scores and the ad parameters (x, y, z) than would be possible using a linear function. Consequently, implementations herein can achieve a higher rank correlation with a ground truth than is possible with a linear function.

Additionally, various different performance indicators may be used as the ground truth, depending on the types of historic information collected or recorded by the ad service. For example, some implementations can simply change the way in which ad-keyword pairs are associated when constructing the directed graph and determining the edge weights. Thus, implementations herein may construct the directed graph based on, for example, click-through rate, number of impressions, number of clicks, number of leads (i.e., a user fills out a form or signs up for a service at a landing page), number of sales, or the like. Furthermore, other techniques may alternatively be used to construct the directed preference graph G, which may lead to even more accurate quality score estimation. For example, implementations herein are able to differentiate ad-keyword pairs and apply different weights to those pairs while changing the edge weights. Other implementations may also consider tied ad-keyword pairs in graph construction. Numerous other variations will be apparent to those of skill in the art in light of the disclosure herein.

### Example Process

FIG. 8 is a flow diagram of an example process 138 for determining a quality score according to some implementations herein. For discussion purposes, the process 138 is described with reference to the framework 100 of FIG. 1 and the system architecture 500 of FIG. 5, although other frameworks, system architectures and environments may implement this process.

At block 802, the quality score component 136 obtains historic data 142 for a plurality of ad-keyword pairs to be used as training data.

At block 804, the quality score component 136 constructs a directed graph based on the historic data. For example, the directed graph may include the ad parameter triples (x, y, z) as the nodes of the graph.

At block 806, the quality score component 136 determines weights of edges of the directed graph based on a ground truth determined from the historic data. For example, the ground truth may be a performance indicator, such as click-through rate, number of impressions, number of clicks, number of leads (i.e., a user fills out a form or signs up for a service at a landing page), number of sales, or the like

At block 808, the quality score component 136 cuts the directed graph into a plurality of subgraphs based on the weights of the edges. For example, the graph may be iteratively cut until a desired number of subgraphs are obtained.

At block 810, the quality score component 136 generates a quality score table containing a plurality of quality score values. Each quality score value in the table may correspond to a different one of the subgraphs in the final iteration.

At block 812, the quality score component 136 optionally performs smoothing of the quality score table using a smoothing function. For example, a greedy smoothing algorithm may be applied to help ensure a monotonic increasing property of the quality score table.

At block 814, the quality score component 136 employs the quality score table to determine a quality score for one or more selected ad-keyword pairs. For example, the quality score component 136 may match the advertisement parameter triple (x, y, z) for a selected ad-keyword pair with a corresponding triple in one of the subgraphs for determining the quality score of the selected ad keyword pair.

At block 816, the advertising component utilizes the quality score in an advertising service. For example, the advertising component may utilize the quality score for various decision making processes, such as when determining whether to display the advertisement, whether to include the advertisement in search results, where to rank the advertisement relative to other advertisements, determining a minimum bid amount, and the like.

### Example Computing Device

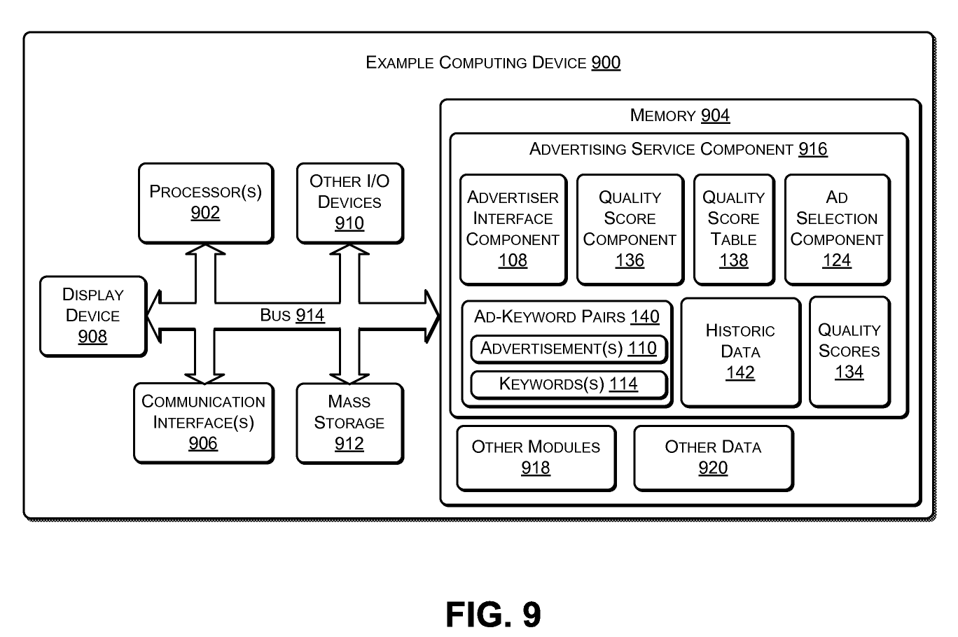

FIG. 9 illustrates an example configuration of a computing device 900 that can be used to implement the components and functions for quality score determination described herein, such as for implementing the quality score component 136 and quality score table 138. In some implementations, the computing device 900 may implement the advertising service 102 described with reference to FIG. 1 and/or the advertising service component 506 described with reference to FIG. 5. The computing device 900 may include at least one processor 902, a memory 904, communication interfaces 906, a display device 908, other input/output (I/O) devices 910, and one or more mass storage devices 912, able to communicate with each other, such as through a system bus 914 or other suitable connection.

The processor 902 may be a single processing unit or a number of processing units, all of which may include single or multiple computing units or multiple cores. The processor 902 can be implemented as one or more microprocessors, microcomputers, microcontrollers, digital signal processors, central processing units, state machines, logic circuitries, and/or any devices that manipulate signals based on operational instructions. Among other capabilities, the processor 902 can be configured to fetch and execute computer-readable instructions or processor-accessible instructions stored in the memory 904, mass storage devices 912, or other computer-readable storage media.

The computing device 900 may also include one or more communication interfaces 906 for exchanging data with other devices, such as via a network, direct connection, or the like, as discussed above. The communication interfaces 906 can facilitate communications within a wide variety of networks and protocol types, including wired networks (e.g., LAN, cable, etc.) and wireless networks (e.g., WLAN, cellular, satellite, etc.), the Internet and the like. Communication interfaces 906 can also provide communication with external storage (not shown), such as in a storage array, network attached storage, storage area network, or the like.

A display device 908, such as a monitor may be included in some implementations for displaying information to users. Other I/O devices 910 may be devices that receive various inputs from a user and provide various outputs to the user, and can include a keyboard, a remote controller, a mouse, a printer, audio input/output devices, and so forth.

Memory 904 and mass storage devices 912 are examples of computer-readable media for storing instructions which are executed by the processor 902 to perform the various functions described above. For example, memory 904 may generally include both volatile memory and non-volatile memory (e.g., RAM, ROM, or the like). Further, mass storage devices 912 may generally include hard disk drives, solid-state drives, removable media, including external and removable drives, memory cards, Flash memory, floppy disks, optical disks (e.g., CD, DVD), a storage array, a network attached storage, a storage area network, or the like. Both memory 904 and mass storage devices 912 may be non-transitory computer storage media, and may collectively be referred to as memory or computer-readable media herein.

Memory 904 and/or mass storage 912 are capable of storing computer-readable, processor-executable instructions as computer program code that can be executed by the processor 902 as a particular machine configured for carrying out the operations and functions described in the implementations herein. For example, memory 904 may include modules and components for determining and applying quality scores according to the implementations herein. In the illustrated example, memory 904 includes an advertising service component 916 that affords functionality for quality score determination. For example, advertising service component 916 may include advertiser interface component 108, ad selection component 124, quality scores 134, quality score component 136, quality score table 138, ad keyword pairs 140, and historic data 142. As described above, quality score component 136 may construct one or more quality score tables 138 and may use quality score table 138 to determine quality scores 134 for ad-keyword pairs 140. Memory 904 may also include one or more other modules 918, such as the auction component 508, the history component 510, and components of the search system 116, such as the query response component 516. Other modules 918 may also include an operating system, drivers, communication software, or the like. Memory 904 may also include other data 920 to carry out the functions described above. Further, while the quality score component 136 has been illustrated and described herein in the environment of an advertising service, other implementations of the quality score component 136 are not limited to use with an advertising service.

Although illustrated in FIG. 9 as being stored in memory 904 of computing device 900, advertising service component 916, or portions thereof, may be implemented using any form of computer-readable media that is accessible by computing device 900. Computer-readable media includes, at least, two types of computer-readable media, namely computer storage media and communications media.

Computer storage media includes volatile and non-volatile, removable and non-removable media implemented in any method or technology for storage of information, such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer-readable storage devices. Thus, the processes, components and modules described herein may be implemented by a computer program product.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

### CONCLUSION

Although the subject matter has been described in language specific to structural features and/or methodological acts, the subject matter defined in the appended claims is not limited to the specific features or acts described above. Rather, the specific features and acts described above are disclosed as example forms of implementing the claims. This disclosure is intended to cover any and all adaptations or variations of the disclosed implementations, and the following claims should not be construed to be limited to the specific implementations disclosed in the specification. Instead, the scope of this document is to be determined entirely by the following claims, along with the full range of equivalents to which such claims are entitled.

1. A method comprising:
under control of one or more processors configured with executable instructions,
selecting an ad-keyword pair for determining a quality score;
determining one or more advertisement parameters for the selected ad-keyword pair;
based at least in part on the one or more advertisement parameters, determining the quality score from a quality score table constructed based at least in part on historic data for a plurality of ad-keyword pairs; and
utilizing the quality score in an advertisement service.

2. The method as recited in claim 1, further comprising constructing the quality score table from the historic data, wherein the historic data comprises historic performance data for the plurality of ad-keyword pairs and a plurality of corresponding advertisement parameters for the plurality of ad-keyword pairs.

3. The method as recited in claim 2, wherein the historic performance data serves as a ground truth for constructing the quality score table and comprises at least one of:
click-through rates for the plurality of ad-keyword pairs;
number of impressions for the plurality of ad-keyword pairs;
number of ad clicks for the plurality of ad-keyword pairs;
number of leads for the plurality of ad-keyword pairs; or
number of sales for the plurality of ad-keyword pairs.

4. The method as recited in claim 2, wherein the advertisement parameters comprise one or more of:
relevance between the keyword and an advertisement of the selected ad-keyword pair;
relevance between the keyword and a landing page for the ad-keyword pair; and
quality of the landing page for the ad-keyword pair.

5. The method as recited in claim 2, wherein constructing the quality score table further comprises constructing a directed graph in which nodes of the graph represent values of ad parameters for the plurality of ad-keyword pairs, and the historic performance data is used to determine weights of edges of the directed graph.

6. The method as recited in claim 5, wherein constructing the quality score table further comprises cutting the directed graph into a plurality of subgraphs, wherein each subgraph represents a quality score value in the quality score table.

7. The method as recited in claim 6, further comprising smoothing the quality score table using a greedy smoothing operation.

8. The method as recited in claim 1, further comprising providing the quality score as feedback to an advertiser that is a source of the selected ad-keyword pair.

9. The method as recited in claim 1, further comprising periodically updating the quality score table as new historic data is collected for the plurality of ad-keyword pairs.

10. A computing device comprising:
one or more processors in operable communication with computer-readable media;
a quality score component executed on the one or more processors to perform operations comprising:
constructing a graph from historic data relating to a plurality of ad-keyword pairs;
cutting the graph iteratively into a plurality of subgraphs;
generating a quality score table containing a plurality of quality score values, each subgraph corresponding to a different quality score value in the quality score table.

11. The computing device as recited in claim 10, wherein the historic data comprises a performance indicator for the plurality of ad-keyword pairs used as a ground truth for constructing the graph.

12. The computing device as recited in claim 11, wherein the performance indicator comprises one of:
click-through rates for the plurality of ad-keyword pairs;
number of impressions for the plurality of ad-keyword pairs;
number of ad clicks for the plurality of ad-keyword pairs;
number of leads for the plurality of ad-keyword pairs; or
number of sales for the plurality of ad-keyword pairs.

13. The computing device as recited in claim 11, wherein the historic data further comprises advertisement parameters for the plurality of ad-keyword pairs, the advertisement parameters comprising one or more of:
relevance between the keyword and an advertisement of an ad-keyword pair;
relevance between the keyword and a landing page for the ad-keyword pair; and
quality of the landing page for the ad-keyword pair.

14. The computing device as recited in claim 10, wherein the graph comprises:
a plurality of nodes that represent values of advertisement parameters for the plurality of ad-keyword pairs; and
a plurality edges, wherein historic performance data of the plurality of ad-keyword pairs is used to determine weights of the plurality of edges of the graph.

15. The computing device as recited in claim 14, wherein the cutting of the graph into subgraphs includes using the weights of the edges to determine to which subgraph each node belongs.

16. The computing device as recited in claim 10, the operations further comprising smoothing the quality score table using a greedy smoothing operation to provide the quality score table with a monotonic increasing property.

17. One or more computer-readable media having instructions stored thereon executable by a processor to perform operations comprising:
obtaining historic data for a plurality of ad-keyword pairs;
constructing a directed graph from the historic data;
determining weights of edges in the directed graph based at least in part on a ground truth determined from the historic data;
cutting the directed graph into a plurality of subgraphs based at least in part on the weights of the edges; and
generating a quality score table having a plurality of quality score values that are related to the plurality of subgraphs.

18. The one or more computer-readable media as recited in claim 17, the operations further comprising smoothing the quality score table using a greedy smoothing function.

19. The one or more computer-readable media as recited in claim 17, the operations further comprising employing the quality score table to determine quality scores for one or more ad-keyword pairs.

20. The one or more computer-readable media as recited in claim 17, wherein each node in the graph corresponds to a triple representing values of three advertisement parameters.
